(19) United States
(12) Patent Application Publication
(10) Pub. No.: US 2008/0167921 A1
(43) Pub. Date: Jul. 10, 2008

(54) ADVERTISEMENT METHOD USING RING TONE PROVIDING SERVICE AND ADVERTISEMENT SYSTEM THEREOF, AND COMPUTER- READABLE MEDIA FOR RECORDING ADVERTISEMENT METHOD PROGRAM

(75) Inventors: Mi Jung Seo, Seoul (KR); Min Seon Jeon, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/971,202

(22) Filed: Jan. 8, 2008

(30) Foreign Application Priority Data
Jan. 9, 2007 (KR) 10-2007-0002543

(51) Int. Cl. G06Q 30/00; G06Q 10/00

(52) U.S. Cl. 705/7

(57) ABSTRACT

An advertisement method using a free ring tone providing service is provided. The advertisement method using the free ring tone providing service includes the steps of: embedding a Digital Rights Management (DRM) code into advertisement contents; acquiring DRM information of the advertisement contents via the DRM code embedded in the advertisement contents when the advertisement contents are replayed with a ring tone in a user terminal of a user being a member of a service which receives the ring tone and the advertisement contents without any financial charge; and charging for the advertisement contents based on the DRM information. Also, an advertisement system using a free ring tone providing service is provided.

### CROSS-REFERENCE TO RELATED APPLICATION

This application claims the benefit of Korean Patent Application No. 10-2007-0002543, filed on Jan. 9, 2007, in the Korean Intellectual Property Office, the disclosure of which is incorporated herein by reference.

### BACKGROUND OF THE INVENTION

1. Field of the Invention

The present invention relates to an advertisement method and an advertisement system, and more particularly, to an advertisement method and an advertisement system using a free ring tone providing service which can provide a user terminal with advertisement contents and a ring tone being paid contents, replay the advertisement contents with the ring tone when the user terminal receives a call, calculate a number of replays of the advertisement contents in the user terminal using Digital Rights Management (DRM) tracking, and charge for the advertisement contents.

2. Description of Related Art

Recently, as a market related to mobile communication terminals available for a wireless Internet communication has been rapidly developed, advertisement services are provided in various types such as a character, a voice, an image, and a movie from enterprises of various fields to embed an advertisement (hereinafter referred to as “advertiser”) via mobile communication terminals of users. These advertisement services generally target many and unspecified users of mobile communication terminals.

However, in the case of the advertisement service for the many and unspecified users of the mobile communication terminals, a user of a mobile communication terminal that receives advertisement contents may dislike receiving advertising contents. Accordingly, a conventional advertisement method may provide a user with an unnecessary image (impression) different from an advertiser's intention.

Also, even though the user of the mobile communication terminal receives the advertising contents, the advertising contents may be frequently deleted or a call may be frequently cut short. Accordingly, there is a problem that the advertiser may not acquire efficiency, compared with a cost invested for an advertisement.

Accordingly, in order to increase an advertising effect via a mobile communication terminal, an advertisement method and an advertisement system which enables a user to download a ring tone being paid contents without any financial charge as compensation for watching advertisement contents via a mobile communication terminal, and to charge based on a number of replays of the advertisement contents via the mobile communication terminal are needed.

### BRIEF SUMMARY OF THE INVENTION

The present invention provides an advertisement method using a free ring tone providing service which can provide a user terminal with advertisement contents and a ring tone being paid contents without any financial charge, replay the advertisement contents with the ring tone when the user terminal receives a call, calculate a number of replays of the advertisement contents in the user terminal using Digital Rights Management (DRM) tracking, and charge for the advertisement contents.

The present invention also provides an advertisement system using a free ring tone providing service. Technical goals of the present invention are not limited to the above-described technical goals, and other unspecified technical goals will be apparent to those skilled in the art from a description as follows.

According to an aspect of the present invention, there is provided an advertisement method using a ring tone providing service, the method including the steps of: embedding a Digital Rights Management (DRM) code into advertisement contents; acquiring DRM information of the advertisement contents via the DRM code embedded in the advertisement contents when the advertisement contents associated with at least one ring tone are played in a user terminal; and charging an account associated with the advertisement contents based, at least in part, upon the acquired DRM information.

In an aspect of the present invention, when the advertisement contents are replayed in the user terminal, the DRM code implements a function of generating the DRM information associated with the advertisement contents and a function of transmitting the DRM information. When the advertisement contents are played in the user terminal, the implementation of said functions by the DRM code embedded in the advertisement contents is not shown to the user. The DRM code can be an advertisement tag including an IRCBot worm.

The step of acquiring includes the steps of: receiving the DRM information when the DRM code is replayed in the user terminal; and updating a number of replays of the advertisement contents based on the DRM information. The step of acquiring further includes the step of storing the DRM information in a database. The DRM information includes a unique identifier of the user terminal and the number of replays of the advertisement contents.

The step of storing classifies the number of replays of the advertisement contents by the unique number of the user terminal and stores, in the database, the numbers of replays of the advertisement contents classified by the unique number of the user terminal.

The step of charging includes the steps of: extracting, from the DRM information, a number of replays of the advertisement contents classified by a unique identifier of the user terminal; calculating advertising cost of the advertisement contents based on the number of replays of the advertisement contents; and demanding the calculated advertising cost. The step of demanding demands the calculated advertising cost by dividing the calculated advertising cost by at least one of a predetermined period unit and a predetermined number unit of replays. The advertisement contents include at least one of text information, image information, and movie information. The user terminal is a mobile communication terminal including a mobile phone function.

According to another aspect of the present invention, there is provided an advertisement system using a free ring tone providing service, the system including: a DRM server configured to be interoperated with a ring tone providing server and an advertisement content providing server, wherein the DRM server includes: a DRM code embedding component configured to embed a DRM code into advertisement contents; a DRM information acquisition component configured to acquire DRM information of the advertisement contents via the DRM code embedded in the advertisement contents when the advertisement contents are replayed with a ring tone in a user terminal of a user being a member of a service which receives the ring tone and the advertisement contents without any financial charge; and a content charging component configured to charge for the advertisement contents to the advertisement content providing server based on the DRM information.

In an aspect of the present invention, the DRM information acquisition component includes: a DRM information receiving component configured to receive the DRM information when the DRM code is replayed in the user terminal; and an update component of a number of replays configured to update a number of replays of the advertisement contents based on the DRM information.

The DRM information acquisition component further includes: a DRM information database configured to store the DRM information. The DRM information includes a unique identifier of the user terminal and the number of replays of the advertisement contents. The DRM information database classifies the number of replays of the advertisement contents by the unique number of the user terminal and stores the numbers of replays of the advertisement contents classified by the unique number of the user terminal. The DRM code includes: a DRM information generation module configured to generate the DRM information associated with the advertisement contents; and a DRM information transmission module configured to transmit the DRM information, and the DRM information receiving component receives the DRM information from the DRM information transmission module. When the advertisement contents are replayed in the user terminal, the DRM code is embedded in the advertisement contents and is performed being hidden from an outside of the advertisement contents.

The content charging component includes: an extraction component of a number of content replays configured to extract, from the DRM information, a number of replays of the advertisement contents classified by a unique identifier of the user terminal; an advertising cost calculation component configured to calculate advertising cost of the advertisement contents based on the number of replays of the advertisement contents; and an advertising cost demanding component configured to demand the calculated advertising cost.

The advertising cost demanding component demands the calculated advertising cost by dividing the calculated advertising cost by at least one of a predetermined period unit and a predetermined number unit of replays.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates a configuration of an advertisement system using a free ring tone providing service according to an exemplary embodiment of the present invention;

FIG. 2 is a block diagram illustrating a configuration of a Digital Rights Management (DRM) server of FIG. 1 in detail;

FIG. 3 is a block diagram illustrating a configuration of a DRM code of FIG. 2;

FIG. 4 is a block diagram illustrating a configuration of a DRM information acquisition component of FIG. 2, in detail;

FIG. 5 is a block diagram illustrating a configuration of a content charging component of FIG. 2, in detail;

FIG. 6 is a flowchart illustrating an advertisement method using a free ring tone providing service according to an exemplary embodiment of the present invention;

FIG. 7 is a flowchart illustrating an operation of providing a user terminal with a ring tone without any financial charge according to a user's request as described with reference to FIG. 6, in detail;

FIG. 8 is a flowchart illustrating an operation of acquiring DRM information of advertisement contents via a DRM code as described with reference to FIG. 6, in detail; and

FIG. 9 is a flowchart illustrating an operation of charging for advertisement contents based on DRM information as described with reference to FIG. 6, in detail.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

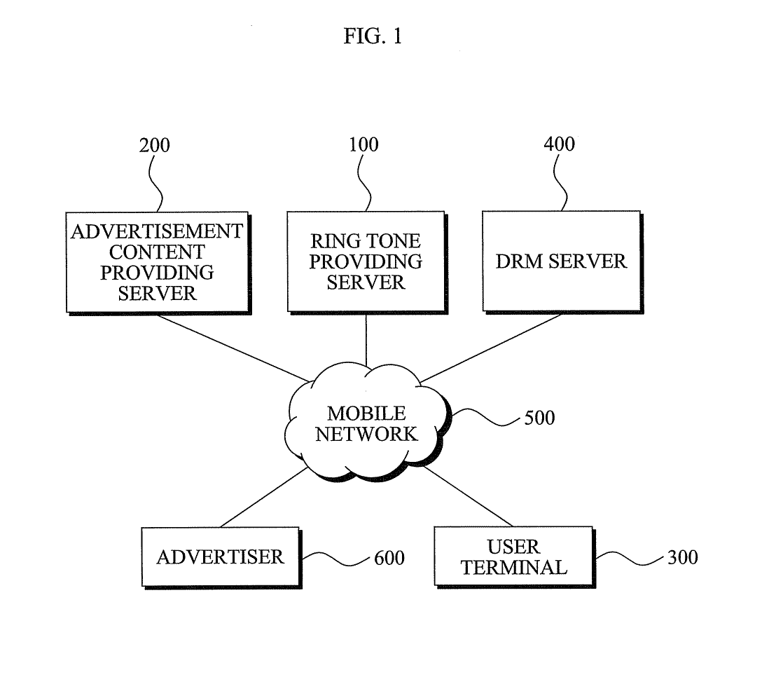

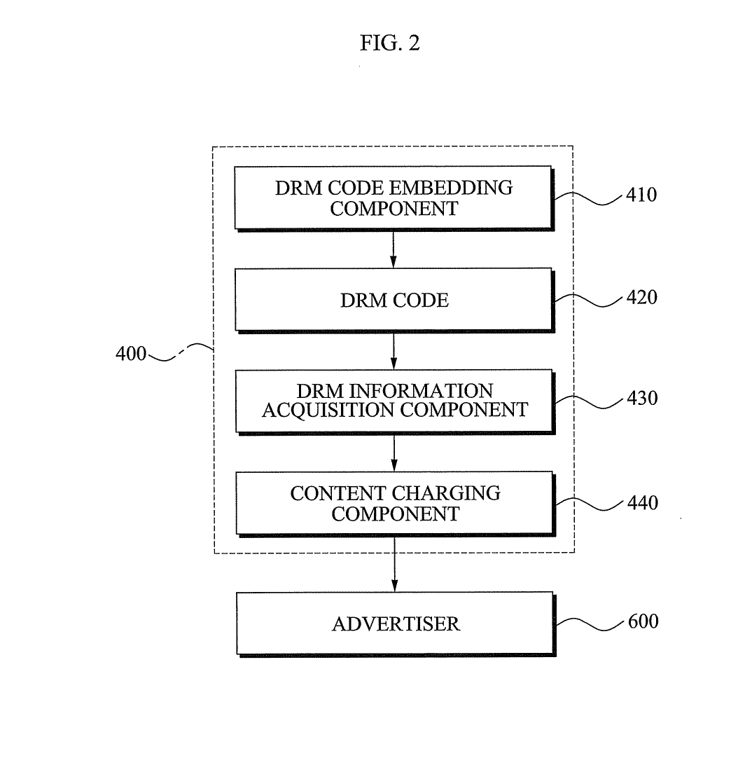

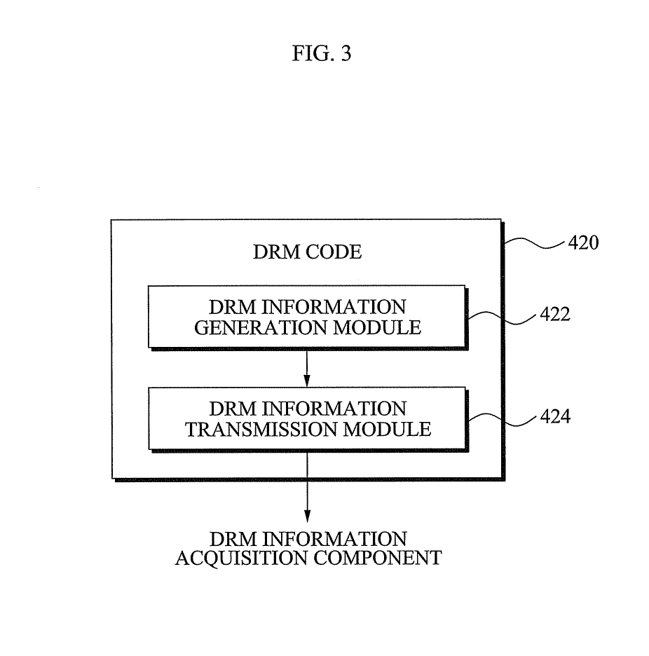

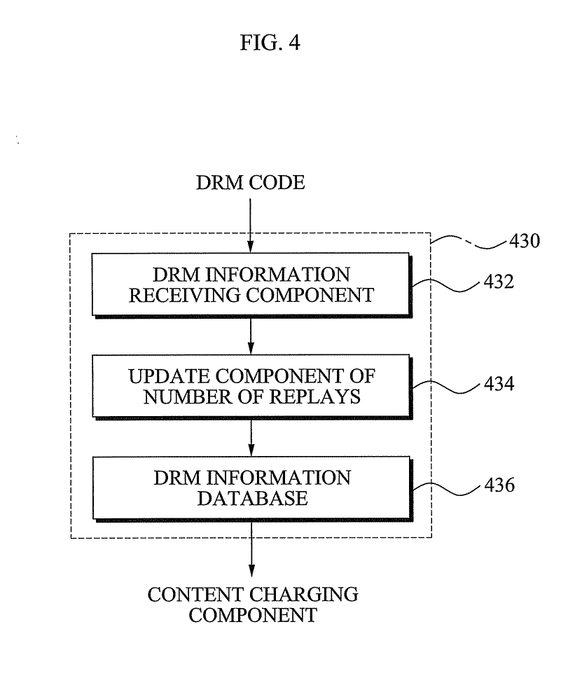

FIG. 1 illustrates a configuration of an advertisement system using a free ring tone providing service according to an exemplary embodiment of the present invention. FIG. 2 is a block diagram illustrating a configuration of a Digital Rights Management (DRM) server of FIG. 1, in detail. FIG. 3 is a block diagram illustrating a configuration of a DRM code of FIG. 2. FIG. 4 is a block diagram illustrating a configuration of a DRM information acquisition component of FIG. 2, in detail.

First, referring to FIG. 1, an advertisement system using a free ring tone providing service according to an exemplary embodiment of the present invention includes a ring tone providing server 100, an advertisement content providing server 200, a user terminal 300, and a DRM server 400.

The ring tone providing server 100 is a server for providing the user terminal 300 with a ring tone. When a user is a member of a service which receives the ring tone and advertisement contents via the user terminal 300, the ring tone providing server 100 provides the user terminal 300 with the ring tone without any financial charge via a mobile network 500.

In this instance, the user may be the member of the service which provides the ring tone and the advertisement contents via a server (not illustrated) being interoperated with the ring tone providing server 100 and the advertisement content providing server 200. The server providing the ring tone and the advertisement contents may include at least one of a web server and a mobile server providing a page enabling the user to select the ring tone and the advertisement contents.

As described above, the user may select the favorite ring tone via the interoperation server, and the interoperation server transmits the ring tone selected by the user to the ring tone providing server 100. Accordingly, the ring tone providing server 100 may provide the user terminal 300 with the ring tone selected by the user without any financial charge.

Here, the mobile network 500 denotes a network connecting between a mobile communication terminal and a fixed point, or between mobile communication terminals, and various mobile communication principles including a cellular mobile communication scheme and the like may be applied.

Also, the mobile network 500 is a wireless station performing a communication with a mobile electrical and electronic apparatus, and a base station relaying electromagnetic waves of the mobile communication terminal, a gateway used for at least one of a function unit and an apparatus for accessing, with each other, a plurality of networks being either different types or the same type and transceiving information between networks, and the like may be used.

The advertisement content providing server 200 is a server for providing the user terminal 300 with the advertisement contents. When the user is the member of the service which receives the ring tone and advertisement contents via the user terminal 300, the advertisement content providing server 200 provides the user terminal 300 with the advertisement contents via the mobile network 500.

In this instance, as described above, the user may be the member of the service which provides the ring tone and the advertisement contents via a server being interoperated with the ring tone providing server 100 and the advertisement content providing server 200.

The advertisement content providing server 200 does not provide the user terminal 300 with the advertisement contents at any time, and provides the user terminal 300 with the advertisement contents when the user terminal 300 receives a call, that is, when the user terminal 300 is called. The user may select the favorite advertisement contents similar to the ring tone, and the interoperation server transmits the advertisement contents selected by the user to the advertisement content providing server 200. Accordingly, the advertisement content providing server 200 may provide the user terminal 300 with the advertisement contents selected by the user.

Here, the advertisement contents include at least one of text information, image information, and movie information. The user terminal 300 receives the ring tone and the advertisement contents from the ring tone providing server 100 and the advertisement content providing server 200. Specifically, as described above, when the user is the member of the service which receives the ring tone and advertisement contents via the user terminal 300, the user terminal 300 downloads the ring tone provided by the ring tone providing server 100 without any financial charge via the mobile network 500, receives the advertisement contents provided by the advertisement contents providing server 200 via the mobile network 500 when receiving the call, and replays the advertisement contents with the ring tone.

Specifically, the user terminal 300 simultaneously replays the ring tone and the advertisement contents when receiving the call. In this instance, the ring tone is outputted via a speaker being an audio output apparatus of the user terminal 300, and the advertisement contents are outputted via a display component being a video output apparatus of the user terminal 300. Accordingly, when the user terminal 300 receives the call, the user may receive the favorite ring tone of the user from the ring tone providing server 100 to the user terminal 300 without any financial charge as compensation for receiving the advertisement contents from the advertisement content providing server 200 to the user terminal 300 and watching the advertisement contents.

The user terminal 300 may include a mobile communication terminal including a mobile phone function. The mobile communication terminal may include a portable device including a communication function, such as a Personal Digital Cellular (PDC) phone, a personal communication service (PCS) phone, a personal handyphone system (PHS) phone, a code division multiple access (CDMA)-2000 (1X, 3X) phone, a Wideband CDMA phone, a dual band/dual mode phone, a global system for mobile communication (GSM) phone, a mobile broadband system (MBS) phone, a Digital Multimedia Broadcasting (DMB) phone, a smart phone, and a cellular phone.

The DRM server 400 embeds a DRM code in the advertisement contents, calculates a number of replays of the advertisement contents in the user terminal 300 using the embedded DRM code, and charges advertising cost to an advertiser 600 based on the calculated number of replays.

Here, DRM is an abbreviation of ‘Digital Rights Management’ and denotes a technology and service protecting interests and rights of parties concerned in copyrights to prevent unauthorized uses of digital contents. The DRM is a technology securely protecting rights and interests of content providers, preventing illegal copies, and collectively supporting content generation, content circulation, and content management such as charging a use fee and acting as a payment agency.

The DRM includes digital copyright management technology which enables only a legitimate user to use contents and pay an appropriate fee, software and security technology for authorizing and executing copyrights, and payment and settlement technology.

The DRM began when Napster, famous for a music sharing service, selected the DRM for protecting copyrights for music files in moving pictures experts group layer 3 (MP3) format in 2001. As on-line contents were being paid for, the DRM rose as an important technology, and was selected as a top ten future core information technology by Massachusetts Institute of Technology in the U.S.

Hereinafter, the term “DRM” denotes the above-described Digital Rights Management. In the present exemplary embodiment, the DRM server 400 applies the DRM to the advertisement contents provided by the advertisement content providing server 200, calculates a number of replays of the advertisement contents in the user terminal 300, and charges advertising cost to the advertiser 600 based on the number of replays of the advertisement contents.

Hereinafter, the DRM server 400 is described in detail with reference to FIG. 2. Referring to FIG. 2, the DRM server 400 includes a DRM code embedding component 410, a DRM information acquisition component 430, and a content charging component 440.

The DRM code embedding component 410 embeds a DRM code 420 having a virus feature in advertisement contents provided by the advertisement content providing server 200. In this instance, the virus feature includes a computer virus feature, and an operation principle of common computer virus features is described as follows.

A computer virus is processed before a normal program. First, the computer virus is embedded after the program and performs a function of changing an initial instruction word of the program to jump to the computer virus. Accordingly, when an infected program is executed, the computer virus is first executed and performs a function of infecting another program and the like. The original program is subsequently executed.

In this instance, a user does not notice anything unusual or simply feels that a speed of a terminal slightly decreases. Accordingly, when the user knows a computer virus exists, a destructive routine generally has already been executed.

A virus code is hidden in a memory area. A portion used little in the program such as a buffer area and a stack area is examined and a code of the computer virus is disposed there. In this instance, a length of an entire program is unchanged. Also, in order to infect a program in which an unused area is small, only a routine indicating a file where the virus is may be put into the program after generating a hidden file in a disk drive.

The computer virus is operated hidden in the normal program. Also, the computer virus may be hidden within another program manufactured for a purpose of spreading the computer virus such as Trojan horse program. The other program may be generally a new version of a game, a useful utility, and a famous commercial program, fake news attractive for computer users, and the like.

As described above, the DRM code 420 has at least one of the above-described virus features. Accordingly, when the advertisement contents provided from advertisement content providing server 200 are replayed in the user terminal 300, implantation of the DRM code 420 is not shown to the user with the advertisement contents. Also, the DRM code 420 can be an advertisement tag including an IRCBot worm.

As illustrated in FIG. 3, the DRM code 420 includes a DRM information generation module 422 and a DRM information transmission module 424. When the advertisement contents provided by the advertisement content providing server 200 are replayed in the user terminal 300, the DRM information generation module 422 generates the DRM information associated with the advertisement contents. Here, the DRM information includes a unique identifier of the user terminal 300 and the number of replays of the advertisement contents.

Specifically, when the advertisement contents provided by the advertisement content providing server 200 are replayed in the user terminal 300, the DRM information generation module 422 generates, in the user terminal 300, the DRM information including the number of replays of the advertisement contents and the like.

The DRM information transmission module 424 transmits the DRM information generated by the DRM information generation module 422 to the DRM information acquisition component 430, and more specifically, to a DRM information receiving component 432 of FIG. 4, and is described as follows.

As illustrated in FIG. 4, the DRM information acquisition component 430 includes a DRM information receiving component 432, an update component 434 of a number of replays, and a DRM information database 436. The DRM information receiving component 432 receives the DRM information from the DRM information transmission module 424 of FIG. 3 when the DRM code is replayed in the user terminal 300.

The update component 434 of the number of replays updates a number of replays of the advertisement contents in the user terminal 300 based on the DRM information received by the DRM information receiving component 432. Specifically, the update component 434 of the number of replays updates the number of replays of the advertisement contents in the user terminal 300 by increasing, by one, the number of replays each time the advertisement contents are replayed in the user terminal 300.

The DRM information database 436 stores the number of replays of the advertisement contents updated by the update component 434 of the number of replays. In this instance, the DRM information database 436 may classify the number of replays of the advertisement contents by the unique number of the user terminal 300 and store the numbers of replays of the advertisement contents classified by the unique number of the user terminal 300.

Specifically, the DRM information database 436 may classify the number of replays of the advertisement contents by the user terminal 300 in which the advertisement contents are replayed, and store the numbers of replays of the advertisement contents classified by the user terminal 300.

For example, it is assumed that a terminal used by person A is referred to as the first user terminal 300 and a terminal used by person B is referred to as the second user terminal 300. In this instance, it is assumed that the first user terminal 300 and the second user terminal 300 are members of a service which receives the ring tone and the advertisement contents, a unique identifier of the first user terminal 300 is 1111111, and a unique identifier of the second user terminal 300 is 2222222. Since the first user terminal 300 receives three calls, advertisement contents ‘a’ are replayed with the ring tone three times. Also, since the second user terminal 300 receives five calls, advertisement contents ‘b’ are replayed with the ring tone five times. In this case, the DRM information database 436 may classify the number of replays of the advertisement contents by the unique number of the user terminal 300 in the following table and store the numbers of replays of the advertisement contents classified by the unique number of the user terminal 300.

| The unique number | The number of replays of |
|---|---|
| of the first user terminal | the advertisement contents |
| 1111111 | 3 |
| 2222222 | 5 |

In the present exemplary embodiment, the DRM information database 436 is included in the DRM information acquisition component 430, however, the DRM information database 436 is not limited thereto and may separately exist.

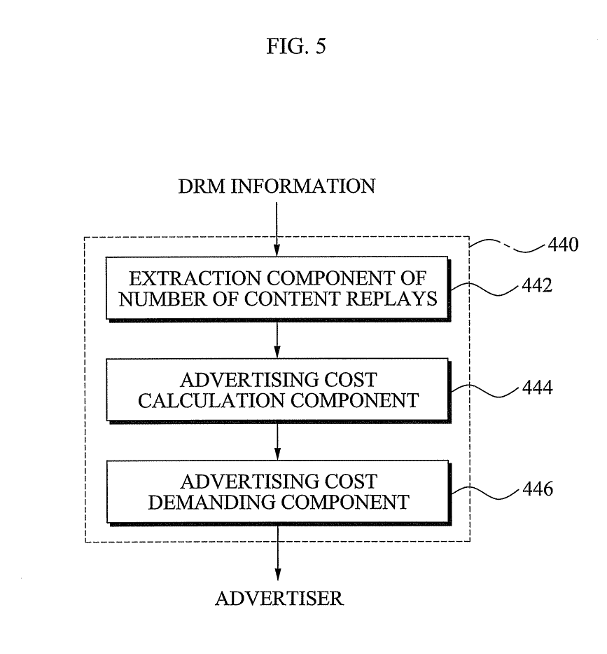

As illustrated in FIG. 5, the content charging component 440 includes an extraction component 442 of a number of content replays, an advertising cost calculation component 444, and an advertising cost demanding component 446.

The extraction component of the number of content replays gets the DRM information from the DRM information database 436 of FIG. 4 and extracts, from the DRM information, a number of replays of the advertisement contents classified by a unique identifier of the user terminal 300.

The advertising cost calculation component 444 totals the number of replays of the advertisement contents classified by the unique number of the user terminal 300 extracted from the extraction component 442 of the number of content replays, and calculates advertising cost of the advertisement contents based on the total number of replays of the advertisement contents.

The advertising cost demanding component 446 demands the advertising cost calculated by the advertising cost calculation component 444 from the advertiser 600. In this instance, the advertising cost demanding component 446 may demand the advertising cost calculated by the advertising cost calculation component 444 by dividing the calculated advertising cost by at least one of a predetermined period unit and a predetermined number unit of replays.

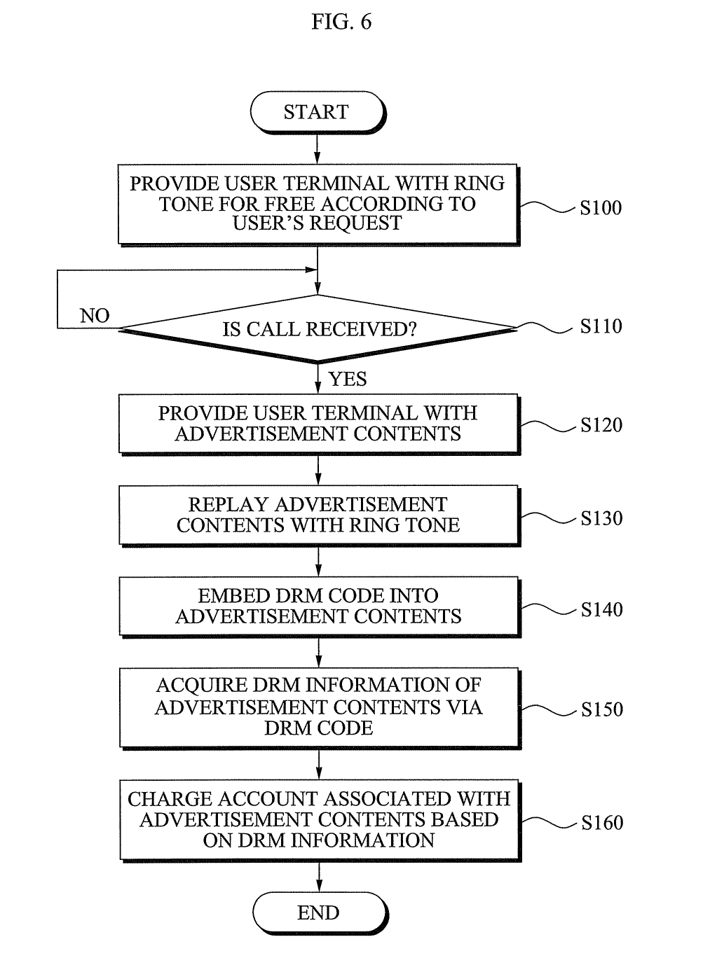

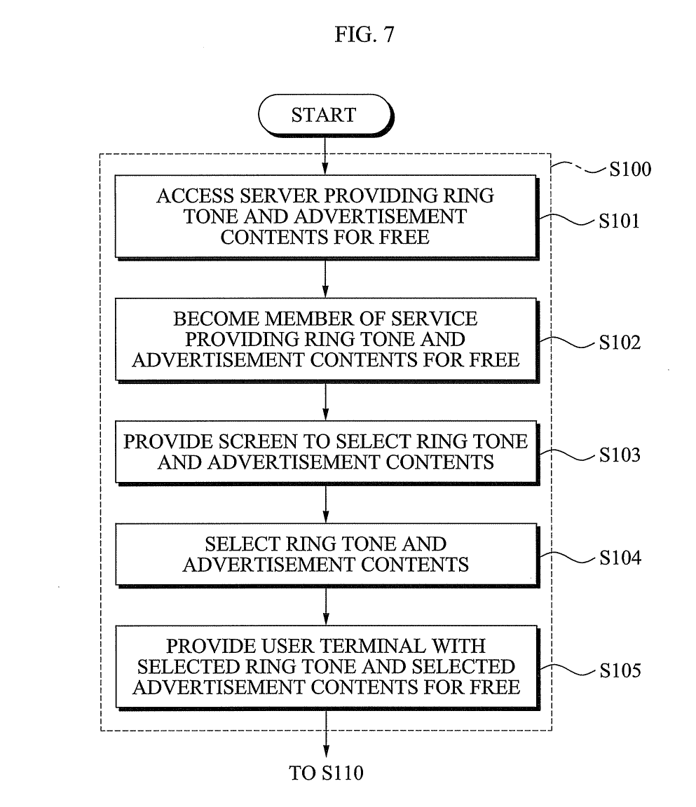

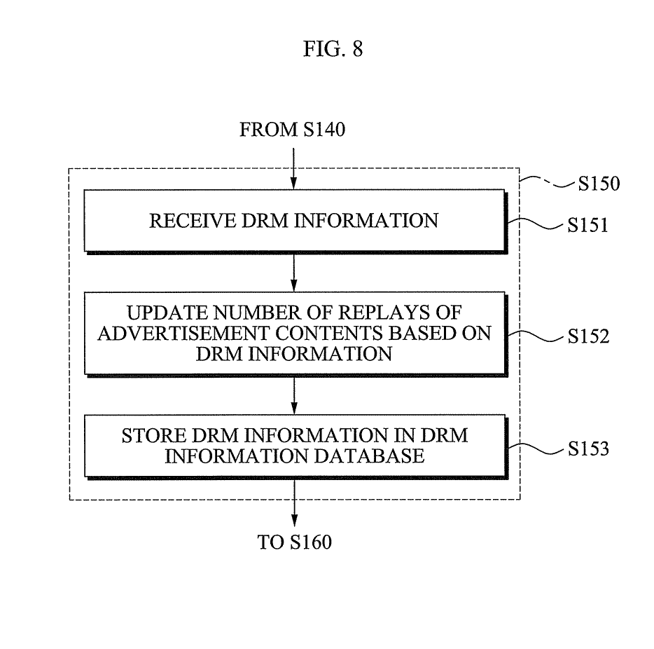

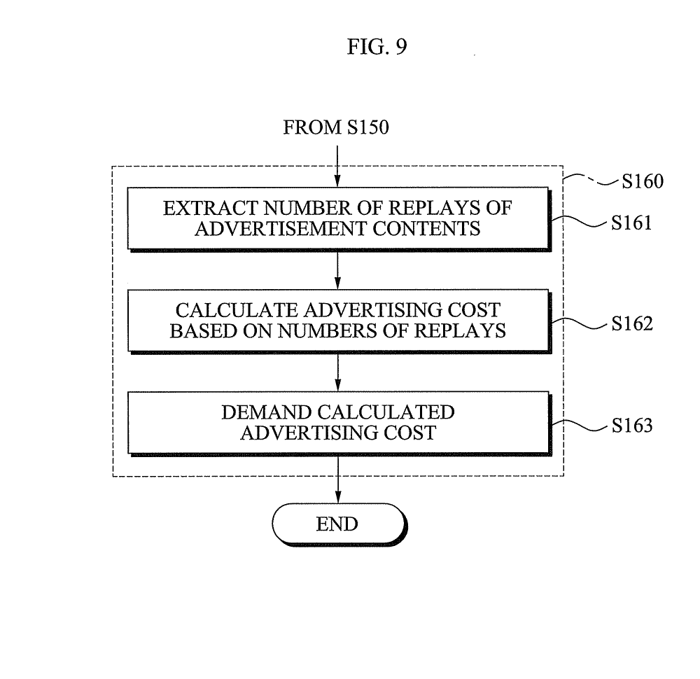

Hereinafter, an advertisement method using a free ring tone providing service according to an exemplary embodiment of the present invention is described. FIG. 6 is a flowchart illustrating an advertisement method using a free ring tone providing service according to an exemplary embodiment of the present invention. FIG. 7 is a flowchart illustrating an operation of providing a user terminal with a ring tone without any financial charge according to a user's request as described with reference to FIG. 6, in detail. FIG. 8 is a flowchart illustrating an operation of acquiring DRM information of advertisement contents via a DRM code as described with reference to FIG. 6, in detail. FIG. 9 is a flowchart illustrating an operation of charging for advertisement contents based on DRM information as described with reference to FIG. 6, in detail.

Referring to FIGS. 1 through 6, in operation S100, the user terminal 300 is provided with a ring tone without any financial charge according to a user's request. When this is described in detail with reference to FIG. 7, in operation S101, a user first accesses a server providing the ring tone and advertisement contents via the user terminal 300.

In this instance, the server providing the ring tone and the advertisement contents may be interoperated with the ring tone providing server 100 and the advertisement content providing server 200, and may include at least one of a web server and a mobile server providing a page enabling the user to select the ring tone and the advertisement contents. Also, the user may access the server providing the ring tone and the advertisement contents without any financial charge via the user terminal 300 such as a mobile communication terminal described above, and a fixed communication terminal such as a personal computer (PC).

In operation S102, the user subsequently becomes a member of a service providing the ring tone and the advertisement contents via the user terminal 300. In this instance, the user performs a service membership authentication using information of the user terminal 300, for example, a telephone number, a unique identifier, and the like. When the service membership authentication succeeds, the user may be the member of the service providing the ring tone and the advertisement contents.

As described above, when the user becomes the member of the service providing the ring tone and the advertisement contents, a screen enabling the user to select the ring tone and the advertisement contents is provided via a display component of the user terminal 300 (including at least one of a liquid crystal display (LCD) screen and an organic light emitting diode (OLED) screen) in operation S103.

When the user subsequently selects the ring tone and the advertisement contents via the screen provided via the display component of the user terminal 300 in operation S104, the ring tone providing server 100 provides the user terminal 300 with the ring tone and the advertisement contents selected by the user without any financial charge in operation S105.

Referring to FIGS. 1 through 6 again, when the user terminal 300 subsequently receives a call in operation S110, the advertisement content providing server 200 provides the user terminal 300 with the advertisement contents selected by the user, in operation S120. In operation S130, the user terminal 300 replays the provided advertisement contents with the ring tone received by the ring tone providing server 100 without any financial charge.

In this instance, in operation S140, the DRM code embedding component 410 of the DRM server 400 embeds a DRM code 420 having a virus feature in the advertisement contents provided for the user terminal 300. Here, since the DRM code 420 has the virus feature, when the advertisement contents are replayed in the user terminal 300, the DRM code 420 is embedded in the advertisement contents replayed in the user terminal 300 and is performed being hidden from an outside of the advertisement contents. Also, the DRM code 420 is an advertisement tag including an IRCBot worm.

When the advertisement contents are replayed in the user terminal 300, the DRM code 420 performs a function of generating the DRM information associated with the advertisement contents via the DRM information generation module 422, and transmitting the generated DRM information via the DRM information transmission module 424.

In operation S150, the DRM information acquisition component 430 of the DRM server 400 subsequently acquires the DRM information of the advertisement contents via the DRM code 420 embedded in the advertisement contents. When this is described in detail with reference to FIG. 8, in operation S151, the DRM information receiving component 432 receives the DRM information transmitted by the DRM information transmission module 424 when the DRM code 420 is replayed in the user terminal 300 in operation S152, the update component 434 of the number of replays updates a number of replays of the advertisement contents in the user terminal 300 based on the DRM information received by the DRM information receiving component 432. In operation S153, the DRM information including the updated number of replays of the advertisement contents is subsequently stored in the DRM information database 436. In this instance, the DRM information database 436 may classify the number of replays of the advertisement contents by the unique number of the user terminal 300 and store the numbers of replays of the advertisement contents classified by the unique number of the user terminal 300.

Referring to FIGS. 1 through 6 again, in operation S160, the content charging component 440 subsequently charges for the advertisement contents based on the DRM information acquired by the DRM information acquisition component 430. Specifically, as illustrated in FIG. 9, in operation S161, the extraction component 442 of the number of content replays gets the DRM information stored in the DRM information database 436 of the DRM information acquisition component 430 and extracts, from the DRM information, a number of replays of the advertisement contents classified by a unique identifier of the user terminal 300. In operation S162, the advertising cost calculation component 444 subsequently sums the numbers of replays of the advertisement contents classified by the unique number of the user terminal 300, and calculates advertising cost of the advertisement contents based on the summed numbers of replays of the advertisement contents. In operation S163, the advertising cost demanding component 446 subsequently demands the advertising cost calculated by the advertising cost calculation component 444 from the advertiser 600.

In this instance, the advertising cost demanding component 446 may demand the advertising cost calculated by the advertising cost calculation component 444 from the advertiser 600 by dividing the calculated advertising cost by at least one of a predetermined period unit and a predetermined number unit of replays.

As described above, the advertisement method and the advertisement system using the free ring tone providing service according to the above-described exemplary embodiments of the present invention may provide the user terminal 300 with the ring tone being paid contents without any financial charge, together with the advertisement contents. Accordingly, the user may receive the desired ring tone without any financial charge, and the advertiser may expose an advertisement on a portable terminal, thereby improving the advertising effect.

Also, an advertising profit may be maximized by charging the advertising cost to the advertiser 600 based on the number of replays of the advertisement contents in the user terminal 300 using DRM tracking when the user terminal 300 receives a call.

Also, the advertisement method and the advertisement system using the free ring tone providing service according to the above-described exemplary embodiments of the present invention may not embed the DRM code in the advertisement contents when a loss is greater than a gain when analyzing a DRM technology introduction cost, reduction of usefulness due to the DRM, user antipathy to tracking, and the like. In this case, the advertising cost of the advertisement contents charged to the advertiser 600 may be based on at least one of a number of downloads of the advertisement contents to the user terminal 300 and a number of received calls.

The advertisement method using the free ring tone providing service according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

The advertisement system and the advertisement method using the free ring tone providing service according to the above-described exemplary embodiments of the present invention have at least one effect as follows.

First, it is possible to provide a user terminal with a ring tone being paid contents without any financial charge as compensation for watching advertisement contents. Accordingly, a user may receive a desired ring tone without any financial charge, and an advertiser may expose an advertisement on a portable terminal, thereby improving an advertising effect.

Second, it is possible to replay advertisement contents with a ring tone when a user terminal receives a call, calculate a number of replays of the advertisement contents in the user terminal using DRM tracking, and charge for the advertisement contents, thereby maximizing an advertising profit.

Third, it is possible to use a user terminal screen as an advertisement inventory, thereby expanding an inventory and increasing advertising sales.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. An advertisement method using a ring tone providing service, the method comprising the steps of:
embedding a Digital Rights Management (DRM) code into advertisement contents;
acquiring DRM information of the advertisement contents via the DRM code embedded in the advertisement contents when the advertisement contents associated with at least one ring tone are played in a user terminal; and
charging an account associated with the advertisement contents based, at least in part, upon the acquired DRM information.

2. The method of claim 1, wherein, when the advertisement contents associated with said at least one ring tone are played in the user terminal, the DRM code implements functions of:
generating the DRM information associated with the advertisement contents; and
transmitting the DRM information to a server.

3. The method of claim 2, wherein, when the advertisement contents are played in the user terminal, the implementation of said functions by the DRM code embedded in the advertisement contents is not shown to the user.

4. The method of claim 3, wherein the DRM code is an advertisement tag including an IRCBot worm.

5. The method of claim 1, wherein the step of acquiring comprises the steps of:
receiving the DRM information when the advertisement contents are played in the user terminal; and
updating a number of replays of the advertisement contents based on the DRM information.

6. The method of claim 5, wherein the step of acquiring further comprises the step of:
storing the DRM information in a database.

7. The method of claim 6, wherein the DRM information includes a unique identifier of the user terminal and the number of replays of the advertisement contents.

8. The method of claim 7, wherein the step of storing classifies the number of replays of the advertisement contents by the unique number of the user terminal and stores, in the database, the numbers of replays of the advertisement contents classified by the unique number of the user terminal.

9. The method of claim 1, wherein the step of charging comprises the steps of:
extracting, from the DRM information, a number of replays of the advertisement contents classified by a unique identifier of the user terminal;
calculating advertising cost of the advertisement contents based, at least in part, upon the number of replays of the advertisement contents; and
charging the account associated with the advertisement contents with the calculated cost.

10. The method of claim 1, said at least one ring tone is provided without any financial charge on condition that the advertisement contents associated with said at least one ring tone is played in the user terminal.

11. The method of claim 1, wherein the advertisement contents include at least one of text information, image information, and movie information.

12. The method of claim 1, wherein the user terminal is a mobile communication terminal including a mobile telephone function.

13. A storage medium encoded with a machine-readable computer program for implementing an advertisement method using a ring tone providing service, the method comprising the steps of:
embedding a Digital Rights Management (DRM) code into advertisement contents;
acquiring DRM information of the advertisement contents via the DRM code embedded in the advertisement contents when the advertisement contents associated with at least one ring tone are played in a user terminal; and
charging an account associated with the advertisement contents based, at least in part, upon the acquired DRM information.

14. An advertisement system using a ring tone providing service, the system comprising:
a DRM server configured to be interoperated with a ring tone providing server and an advertisement content providing server,
wherein the DRM server comprises:
a DRM code embedding component configured to embed a DRM code into advertisement contents;
a DRM information acquisition component configured to acquire DRM information of the advertisement contents via the DRM code embedded in the advertisement contents when the advertisement contents associated with at least one ring tone are played in a user terminal; and
a content charging component configured to charge an account associated with the advertisement contents based, at least in part, upon the acquired DRM information.

15. The system of claim 14, wherein the DRM information acquisition component comprises:
a DRM information receiving component configured to receive the DRM information when the DRM code is played in the user terminal; and
an update component of a number of replays configured to update a number of replays of the advertisement contents based on the DRM information.

16. The system of claim 15, wherein the DRM information acquisition component further comprises:
a DRM information database configured to store the DRM information.

17. The system of claim 16, wherein the DRM information includes a unique identifier of the user terminal and the number of replays of the advertisement contents.

18. The system of claim 17, wherein the DRM information database classifies the number of replays of the advertisement contents by the unique number of the user terminal and stores the numbers of replays of the advertisement contents classified by the unique number of the user terminal.

19. The system of claim 15, wherein the DRM code comprises:
a DRM information generation module configured to generate the DRM information associated with the advertisement contents; and
a DRM information transmission module configured to transmit the DRM information, and
the DRM information receiving component receives the DRM information from the DRM information transmission module.

20. The system of claim 19, wherein, when the advertisement contents are played in the user terminal, the implementation of said functions by the DRM code embedded in the advertisement contents is not shown to the user.

21. The system of claim 14, wherein the content charging component comprises:
an extraction component configured to extract, from the DRM information, a number of replays of the advertisement contents classified by a unique identifier of the user terminal;
an advertising cost calculation component configured to calculate advertising cost of the advertisement contents based, at least in part, upon the number of replays of the advertisement contents; and
an advertising cost demanding component configured to demand the calculated advertising cost.

22. The system of claim 21, where in the advertising cost demanding component demands the calculated advertising cost by dividing the calculated advertising cost by at least one of a predetermined period unit and a predetermined number unit of replays.
